(19) United States
(12) Patent Application Publication
(10) Pub. No.: US 2020/0366141 A1
(43) Pub. Date: Nov. 19, 2020

(54) INDUCTION MOTOR

(71) Applicant: STARROTOR CORPORATION, College Station, TX (US)

(72) Inventors: Michael J. Van Steenburg, Garden Ridge, TX (US); Mark T. Holtzapple, College Station, TX (US)

(21) Appl. No.: 16/763,544

(22) PCT Filed: Nov. 13, 2018
(86) PCT No.: PCT/US18/60856

§ 371 Date: May 12, 2020

Related U.S. Application Data
(60) Provisional application No. 62/585,454, filed on Nov. 13, 2017.

(51) Int. Cl. H02K 1/22; H02K 1/12

(52) U.S. Cl. CPC H02K 1/22; H02K 2201/03; H02K 2201/06; H02K 1/12

(57) ABSTRACT

Electrical machines such as electromagnetic devices rely on the magnetic flux to create the forces required to move the component that transfers the work output of the device. The present invention achieves that through a unique stator pole to rotor/actuator pole configuration that maximizes the magnetic flux flow across the air gap(s). This is achieved by tilting the air gap in more than one plane with respect to the rotation plane of the rotor.

### CROSS-REFERENCE TO RELATED APPLICATIONS

This application is a United States national stage filing of PCT Application No. PCT/US18/60856 filed on Nov. 13, 2018, which claims priority to U.S. Provisional Application No. 62/585,454 filed on Nov. 13, 2017. This application claims the benefit and priority of U.S. Provisional Application No. 62/585,454.

### TECHNICAL FIELD

This invention relates to electric machines and, more particularly, to electromagnetic devices such as rotary motors and generators, and linear actuators and solenoids.

### BACKGROUND

In generators, input energy is mechanical work and output energy is electrical work. In motors, input energy is electrical work and output energy is mechanical work. Most electrical machines are reversible and can function as either motors or generators.

In motors, electrical energy input imparts motion to one or more components of the machine, such as rotors, solenoids, or actuators. Solenoids and actuators typically move linearly whereas rotors rotate.

Many modern applications of electric motors require high power density. For example, modern automobiles increasingly use electrical energy in either hybrid vehicles or battery vehicles. Automobile performance is significantly enhanced with lightweight electric motors mounted directly on the automobile body or its wheels. At a given motor speed, high power density requires high torque density.

### SUMMARY OF THE DISCLOSURE

The present disclosure relates to electrical machines and more specifically to electrical machines that do work on moving objects. The present invention has numerous unique features that maximize the magnetic flux density in a magnetic circuit for electromagnetic motors, generators, solenoids, and actuators.

The rotor moves through the stator magnetic circuit at an angle; thus, the surface area between the rotor and stator is increased, which reduces the reluctance and increases the magnetic flux in the circuit. The result is greater magnetic force between the stator and rotor pole, and hence greater torque.

If the air gaps that the rotor passes through are angled with respect to the major magnetic flux path through the stator and rotor pole loop, then the surface area of the air gap will be maximized, as a function of the sine of the angle between the major magnetic flux path and the direction of rotation of the rotor pole, and result in a greater magnetic force between the stator and rotor pole.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

### BRIEF DESCRIPTION OF THE DRAWINGS

For a more complete understanding of this disclosure and its features, reference is now made to the following description, taken in conjunction with the accompanying drawings and tables, in which:

FIG. 1 shows the direction of a magnetic field as current flows through a wire;

FIG. 2 shows how a solenoid combines magnetic field lines to create a more intense magnetic field;

FIG. 3 shows a solenoid;

FIG. 4 shows a table of properties of magnetic permeability;

FIG. 5 shows a wire conductor inserted into tube with high magnetic permeability;

FIG. 6 shows the force between parallel wires electrical current;

FIG. 7 shows an orientation of magnetic field, current, and force;

FIG. 8 shows the forces of attraction and repulsion between parallel wires, depending upon the direction of the current;

FIG. 9 shows a simple DC electric motor illustrating how force can be generated by the interaction of electric current with a magnetic field;

FIG. 10 shows magnetic flux through a coil;

FIG. 11 shows induced eddy current;

FIG. 12 shows a table of electrical conductivity;

FIG. 13 shows a schematic of a three-phase, two-pole induction motor;

FIG. 14 shows a net magnetic field from the stator rotates;

FIG. 15 shows a squirrel cage rotor;

FIG. 16 show typical torque production as a function of slip g.

FIG. 17A shows a schematic of a TORQFLUX™ induction motor, according to an embodiment of the disclosure;

FIG. 17B shows a schematic of a TORQFLUX™ induction motor with holes, according to an embodiment of the disclosure;

FIG. 17C shows a schematic of a TORQFLUX™ induction motor with slots, according to an embodiment of the disclosure;

FIG. 17D shows a schematic of a TORQFLUX™ induction motor with plugs of plugs of high-permeability electromagnetic material, according to an embodiment of the disclosure;

FIG. 17E shows a schematic of a TORQFLUX™ induction motor with plugs of high-permeability electromagnetic material and slots, according to an embodiment of the disclosure;

FIG. 17F shows a schematic of tapered plug of high-permeability electromagnetic material in the rotor, according to an embodiment of the disclosure;

FIG. 18 shows a schematic of a TORQFLUX™ induction motor that doubles the torque, according to an embodiment of the disclosure;

FIG. 19 shows a schematic of a TORQFLUX™ induction motor that triples the torque, according to an embodiment of the disclosure;

FIG. 20 shows a schematic of a TORQFLUX™ induction motor with three phases, according to an embodiment of the disclosure;

FIG. 21 shows a one-phase stator, according to a embodiment of the disclosure;

FIG. 22 shows a three-phase stator, according to an embodiment of the disclosure;

FIG. 23 shows aspects of a magnetic circuit with a flat blade and example dimensions;

FIG. 24 shows magnetic properties of 0.012-in-thick grain-oriented M-5 electrical steel;

FIG. 25 shows magnetic permeability of 0.012-in-thick grain-oriented M-5 electrical steel;

FIG. 26 shows forces on a flat blade for the example dimension in FIG. 23;

FIG. 27 shows the magnetic flux through the magnetic circuit shown in FIG. 23;

FIG. 28 shows flux density in the core of the magnetic circuit shown in FIG. 23;

FIG. 29 shows the flux density in the air gap of the magnetic circuit shown in FIG. 23;

FIGS. 30A-30D are examples showing high-surface-area air gaps;

FIGS. 31A-31B shows an electric motor/generator with rotor outside the stator, according to an embodiment of the disclosure;

FIGS. 32A-32B shows an electric motor/generator with rotor outside the stator, according to an embodiment of the disclosure;

FIG. 33 show iron laminations that form a magnetic circuit according to embodiment of the disclosure;

FIGS. 34A-34E show non-limiting options for the iron in the magnetic circuit, according to an embodiment of the disclosure;

FIG. 35 shows a rotor closing the gaps in the magnetic circuit shown in FIG. 34A;

FIG. 36 shows the rotor closing the gaps in the magnetic circuit shown in FIG. 34C;

FIG. 37 shows the rotor closing the gaps in the magnetic circuit shown in FIG. 34E;

FIG. 38A shows the magnetic circuits previously described in FIG. 34A with no magnetic shielding;

FIG. 38B shows the magnetic circuits previously described in FIG. 34A with magnetic shielding;

FIG. 39A shows a thermosiphon in which liquid coolant boils inside a torus;

FIG. 39B shows a pumped liquid coolant that flows through the torus FIG. 39C shows the torus is part of a Rankine cycle engine;

FIG. 39C shows the torus is part of a Rankine cycle engine

FIG. 40A shows a Halbach array in which the magnetic fields align to produce a strong magnetic field on one side and a weak magnetic field on the other;

FIG. 40B shows an arrangement used with the magnetic circuit shown in FIG. 34A;

FIG. 40C shows an arrangement used with the magnetic circuit shown in FIGURES shown in FIGS. 34B, 34C, and 34E.

### DETAILED DESCRIPTION

The FIGURES described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

### Electromagnetism Fundamentals

The following electromagentism fundamentals are provided for an understanding of certain aspects of embodiments of the disclosure. Such an explanation should not be viewed as limiting the inventive aspects of the disclosure.

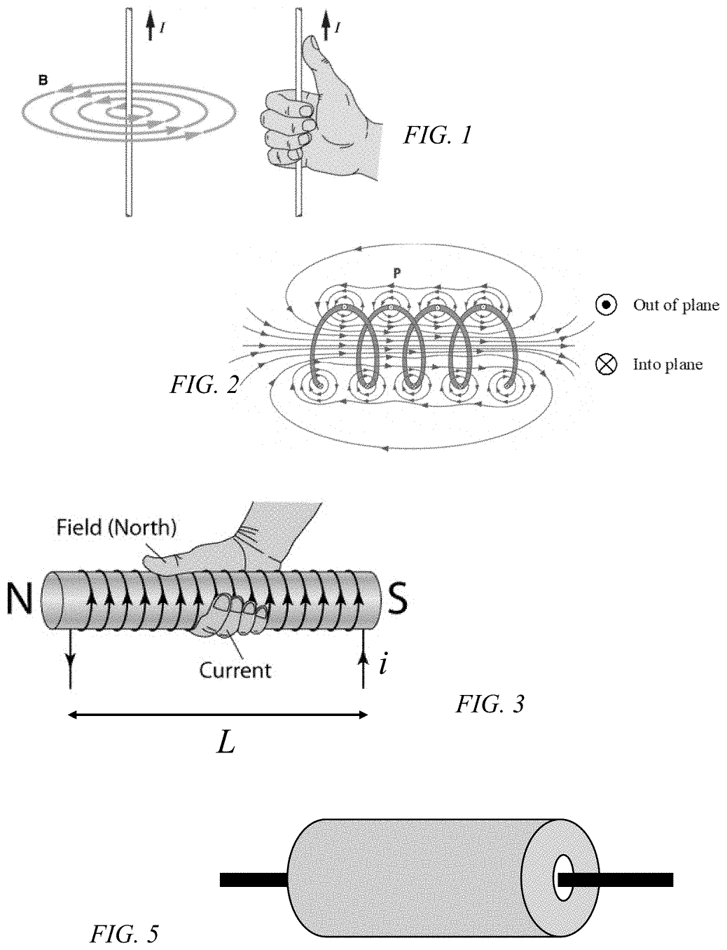

When current flows through a wire, a magnetic field forms around the wire, for example, as seen in FIG. 1. The right-hand grip rule shows the direction of the magnetic field. By wrapping the wire into a solenoid, the magnetic field lines combine and strengthen as seen in FIG. 2. When the right hand is wrapped around the solenoid as shown in FIG. 3, the north direction of the magnetic field is determined.

In a solenoid, the strength of the magnetic field is determined by the following relationship:

$$B = μ ( \frac{N}{L} i ) = μH \qquad ( 1 )$$

where

B=magnetic flux density (Wb/m² or tesla)

H=magnetic field intensity (A·turn/m)

p=magnetic permeability (Wb/(A·turn·m) or H/m)

N=number of turns

L=solenoid length (m)

i=current (A)

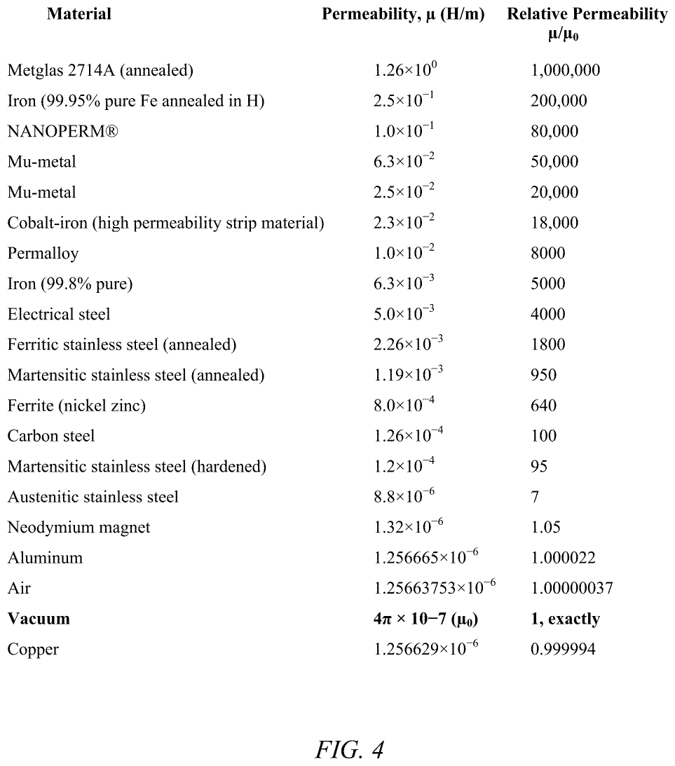

The magnetic permeability depends on the material at the core of the solenoid, and is often expressed relative to the magnetic permeability of a perfect vacuum, as shown by the Table in FIG. 4 (which shows permeability and relative permeability for a variety of materials). Although select material are provided in FIG. 4, the lack of a material or inclusion should in no way be interpreted as requiring such a material in an embodiment of the disclosure or excluding materials not listed from an embodiment of the disclosure.

Placing a wire inside of a tube constructed of a material with high magnetic permeability allows large magnetic fields to surround the wire as seen in FIG. 5.

### Superconductors

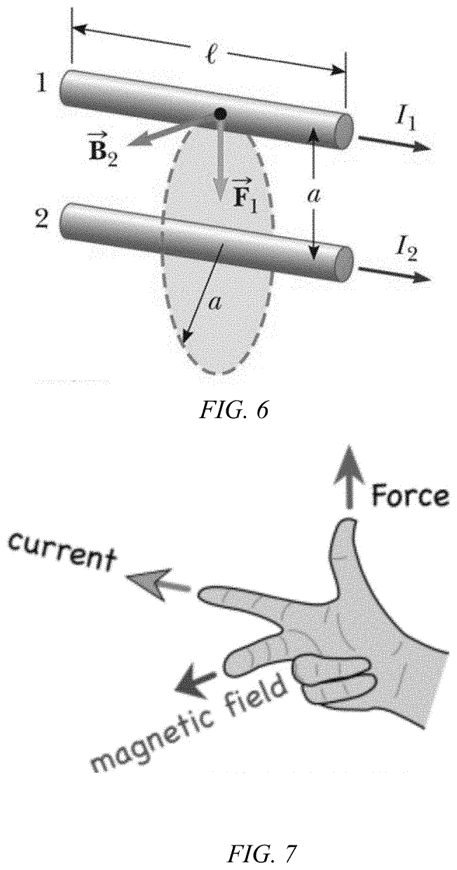

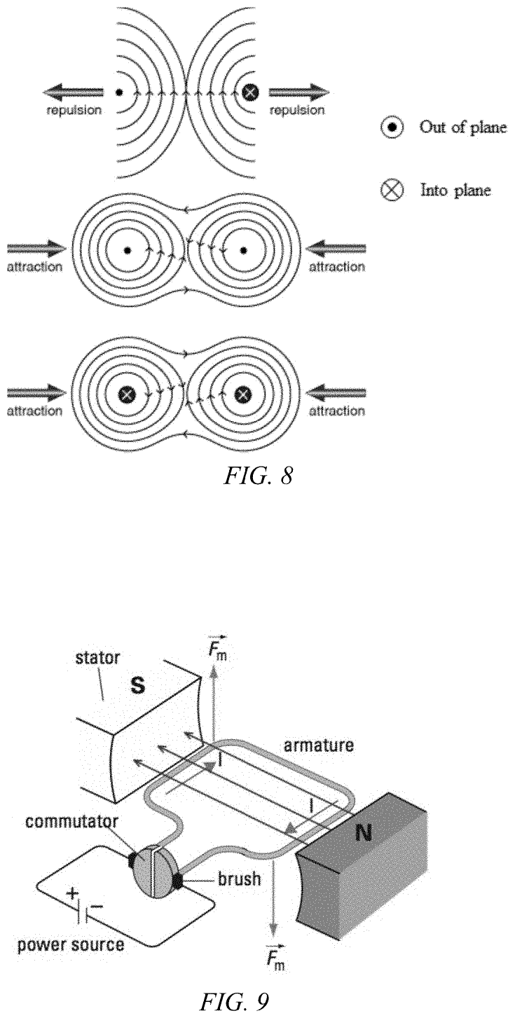

When current flows through conductors, magnetic fields and forces are established as seen in FIGS. 6 and 8. The right-hand rule, as seen in FIG. 7, show the relative orientation of the current, magnetic field, and force. FIG. 8 particularly shows the forces of attraction and repulsion between parallel wires, depending upon the direction of the current FIG. 9 shows a simple DC electric motor that generates a force (torque) when electric current flows through wire in a magnetic field. The right-hand rule (FIG. 7) determines the relationship between current, magnetic field, and force.

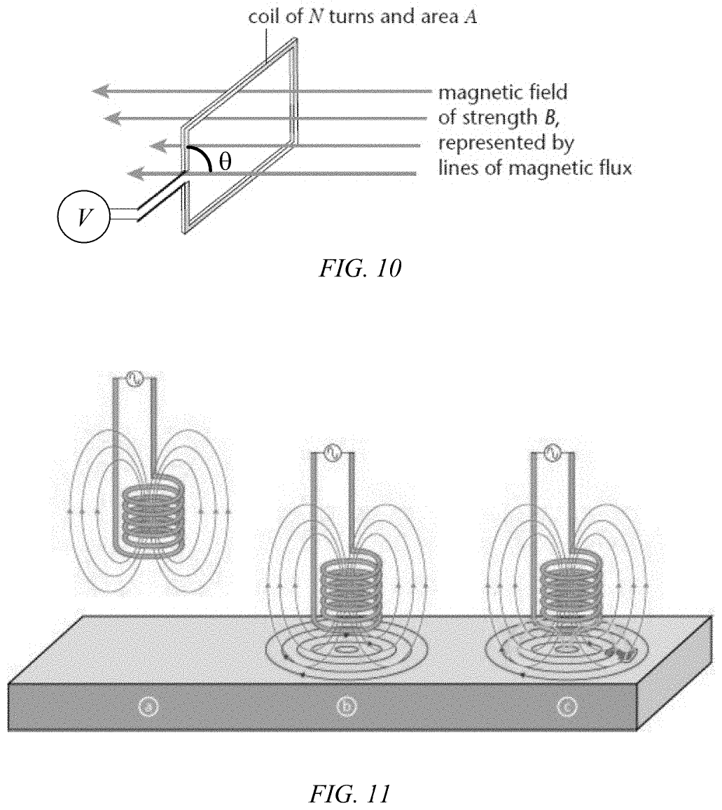

As shown in FIG. 10, magnetic flux is related to magnetic flux density as follows:

Φ_{B}=BA_{⊥}=BA sin θ (2)

where

Φ_{B}=magnetic flux (Wb)

B=magnetic flux density (Wb/m² or tesla)

A=area (m²)

A_{⊥}=projected area perpendicular to the field lines (m²)

═angle between field lines and area

Faraday's Law states that when a conductor interacts with changing magnetic field it induces a voltage through a conducting coil (FIG. 10).

$$V = - N \frac{d {Φ}_{B}}{d t} \qquad ( 3 )$$

where

V=voltage (V)

N=number of turns on coil

t=time (s)

As shown in FIG. 10, in a constant magnetic field, a voltage can be generated by changing angle θ. Alternatively, if angle θ is fixed, when the magnetic field is changed, a voltage will be generated.

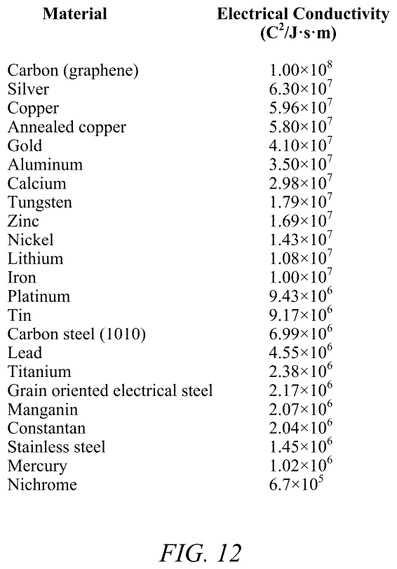

According to Faraday's law, a voltage will be induced when a magnetic field interacts with a solid conductor (FIG. 11). In essence, the conductor is a closed coil, so eddy currents are produced in the conductor. Energy is dissipated through electrical resistance in the conductor. To improve energy efficiency, a conductor with high electrical conductivity should be employed when inducing currents as shown in the Table of FIG. 12 (which shows a variety of materials and their electrical conductivity). Although select material are provided in FIG. 12, the lack of a material or inclusion should in no way be interpreted as requiring such a material in an embodiment of the disclosure or excluding materials not listed from an embodiment of the disclosure.

Lenz's law states that the induced current will establish a magnetic field that resists change from the applied magnetic field. It is reflected in the negative sign of Equation 3 infra.

### Conventional Induction Motor

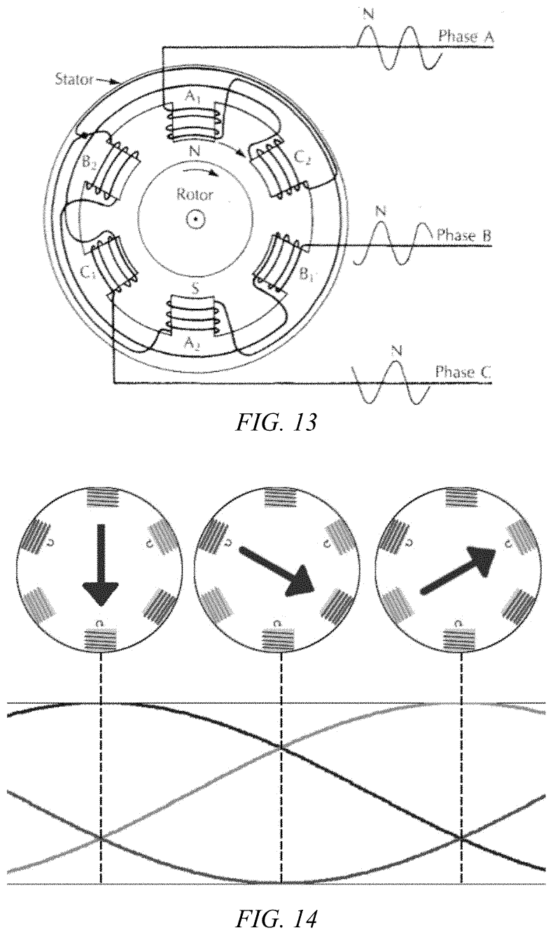

FIG. 13 shows a schematic of a three-phase, two-pole induction motor. Current is provided to opposite pairs of solenoids, A₁-A₂, B₁-B₂, and C₁-C₂. The wiring causes one member of the pair to establish a north pole and the other to establish a south pole. Each pair is 120 degrees out of phase with its neighbor. The net magnetic field rotates as shown by the large arrow in FIG. 14. In the United States, the rotation rate is 60 Hz.

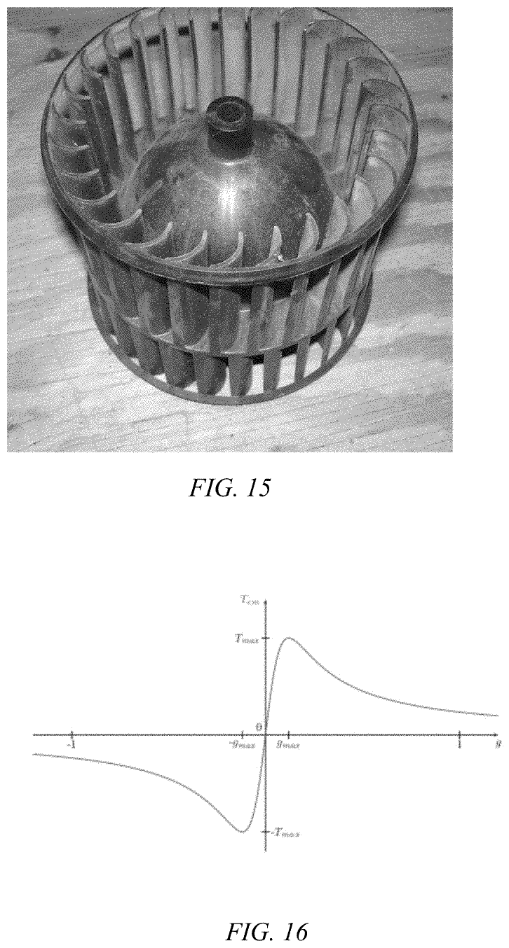

In principle, the rotor could be a solid conductor (e.g., copper). In practice, the rotor often is comprised of a “squirrel cage,” for example as seen in FIG. 15 that effectively has many conducting loops analogous to the coils shown in FIGS. 9 and 10. According to Faraday's law, because of the applied magnetic field, current is induced in the conductor. According to Lenz's law, the induced currents produce an opposing magnetic field that resists the applied magnetic field. If no load is applied to the rotor, it rotates at exactly the same rate as the applied magnetic field; in effect, because of Lenz's law, it can perfectly counter the applied magnetic field. If there is an applied load, the rotor slips and cannot perfectly counter the applied load. FIG. 16 shows the amount of torque typically generated as a function of slip g. The amount of slip self-regulates the torque output from an induction motor, so a controller is not required.

This discussion focuses on three-phase induction motors; however, it is understood that one-phase induction motors are used as well. Furthermore, the number of poles can differ. For example, a four-pole motor will rotate at half speed (30 Hz in the United States). Increasing the number of poles decreases the speed proportionally.

### TORQFLUX™ Induction Motor

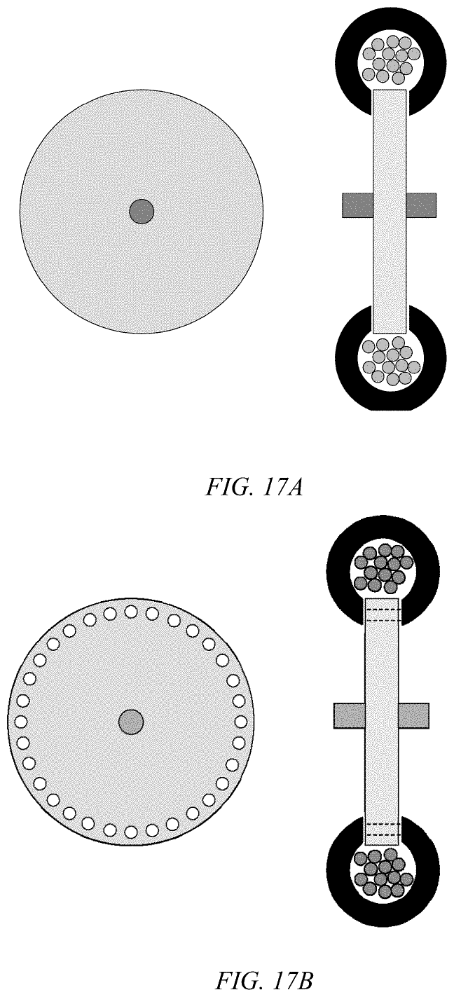

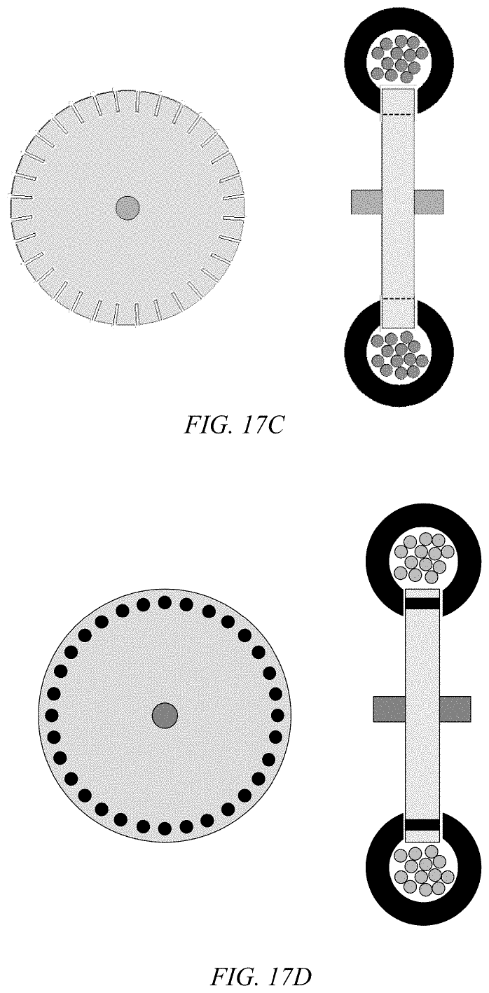

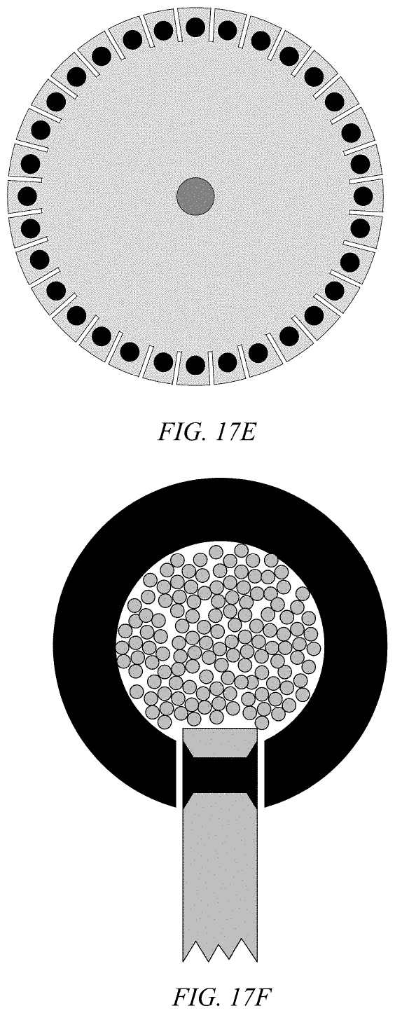

FIGS. 17A-17E show schematics of Option A configurations, according to embodiments of the disclosure.

FIG. 17A shows a schematic of a TORQFLUX™ induction motor (Option A), according to an embodiment of the disclosure. The central disc is electrically conductive in the outer rim. Optionally, the periphery has a series of holes (FIG. 17B) or slots (FIG. 17C), which are analogous to the squirrel cage of a standard induction motor. These holes or slots help guide the current, which reduces interference between the induced currents and improves efficiency.

Surrounding the periphery is an array of C-shaped high-permeability electromagnetic material. The core has electrically conducting coils. Because the coils are surrounded by high-permeability material, large magnetic fields are generated (see FIG. 5). As AC current is added to the electrically conducting coil, it induces a current in the conducting disc. According to Lenz's law, the induced current will repel the applied magnetic field causing the disc to rotate about the central axis (shown in blue). To increase the strength of the magnetic field in the ring, the disc can be constructed from a sintered metal composite consisting of a mixture of materials with high electrical conductivity (e.g., copper) and high magnetic permeability (e.g., iron).

In the case of a three-phase induction motor, three independent segments will be employed each traversing 120 degrees of the circumference. In the case of a single-phase induction motor, a single coil will surround the entire 360 degrees.

FIG. 17D shows an alternative embodiment of Option A in which the holes of the central disc are filled with “plugs” of high-permeability electromagnetic material, for example, as shown with reference to the materials in FIG. 4. This approach allows the magnetic circuit to be completed with high-permeability material and hence produce a strong magnetic field. This strong magnetic field will induce a large current in the periphery of the central disc, which is constructed of a material with high electrical conductivity (FIG. 12), such as copper. FIG. 17E shows an alternative embodiment that employs slots between the plugs, which increases surface area for cooling and isolates the counter-rotating current around each plug.

The gap between the stator and rotor is a major “resistance” in the magnetic circuit. The reluctance of this gap can be minimized by increasing the diameter of the plug of high-permeability electromagnetic material. Unfortunately, this approach removes a substantial amount of material from the surrounding electrically conducting material, which will increase electrical resistance and reduce motor efficiency. A compromise between these two competing effects is achieved by tapering the ends of the plug (as seen in FIG. 17F).

It is understood that the alternative embodiments illustrated in FIG. 17A to 17F may be employed in other options described hereafter.

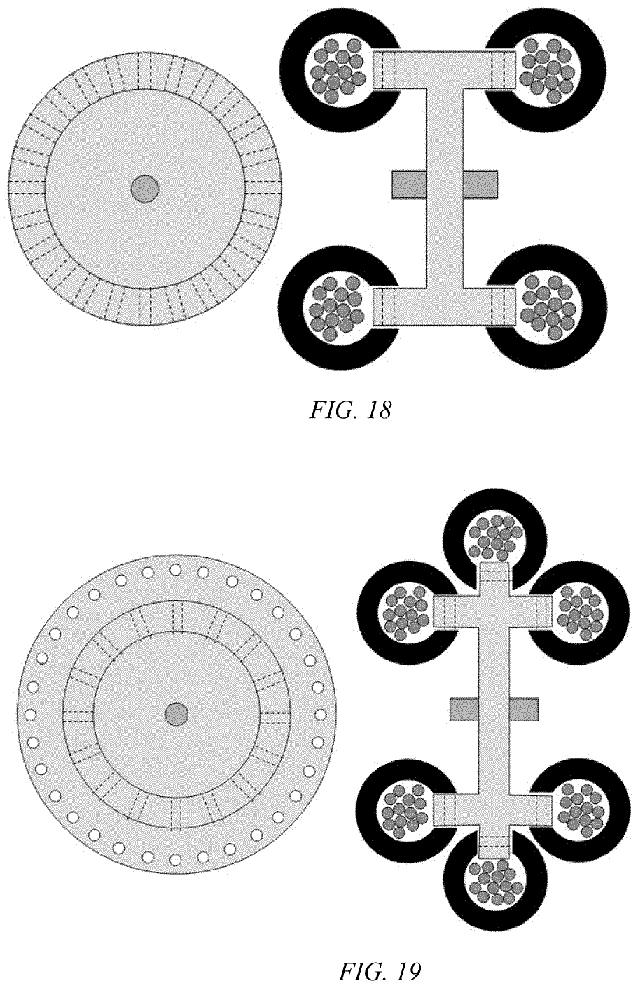

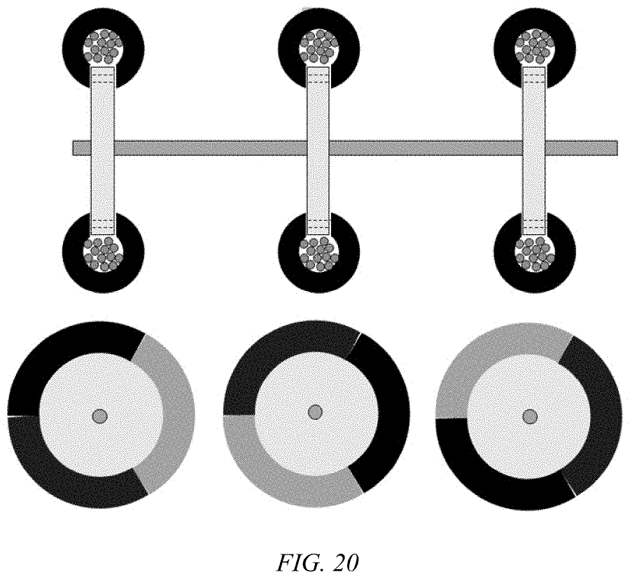

FIG. 18 shows another Option B, which doubles the torque, as seen through a doubling of the C-shaped materials. FIG. 19 Option C, which triples the torque. Figure as seen through a tripling of the C-shaped materials. FIG. 20 shows Option D, a three-phase version. Each phase is present on each disc, and is rotated 120 degrees compared to its adjacent disc. This approach makes full use of the wire; nearly all the wire is surrounded by high-permeability material.

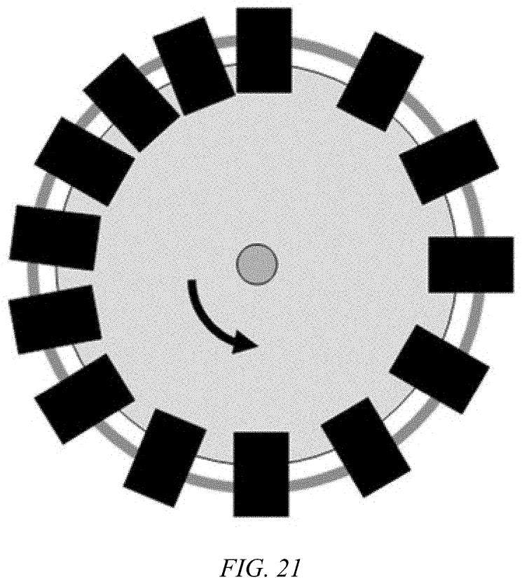

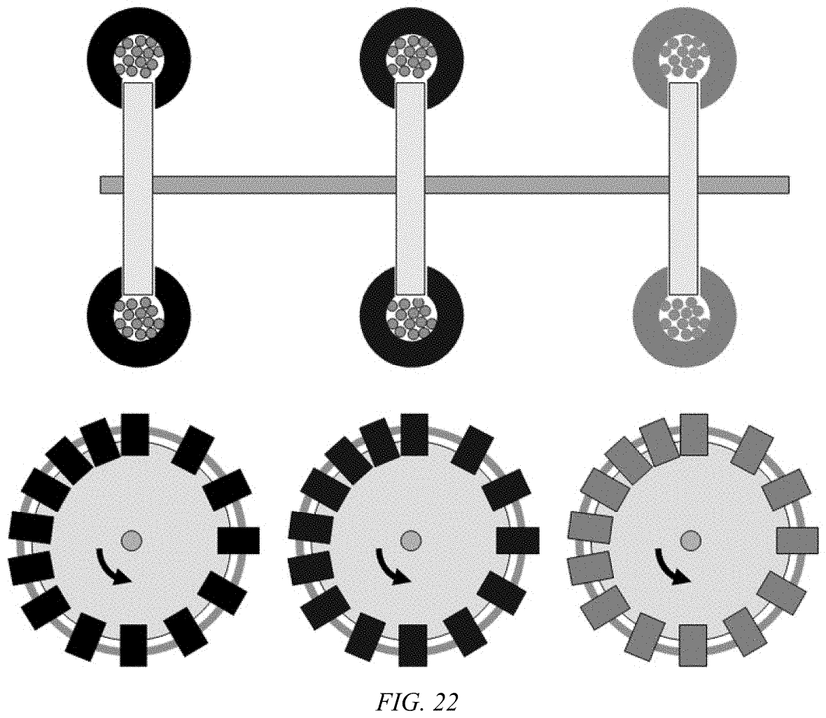

The segments of high-permeability magnetic rings can be arranged along the periphery as shown in FIG. 20. Over some portions of the circumference, the angular density of the rings is high and other portions, the angular density is low; thus, there is a gradient in the angular density of rings. The direction of rotation is established by the gradient. In regions with a high angular density of rings, the magnetic field strength is high. In contrast, in regions with a low angular density of rings, the magnetic field strength is low. This arrangement produces an uneven magnetic field along the circumference. Through Lenz's law, the rotor will be “magnetically squeezed” and will rotate in an attempt to minimize the impact of the applied magnetic field. This arrangement can be used in a single-phase motor (FIG. 21) or a three-phase motor (FIG. 22).

### Flat Blade

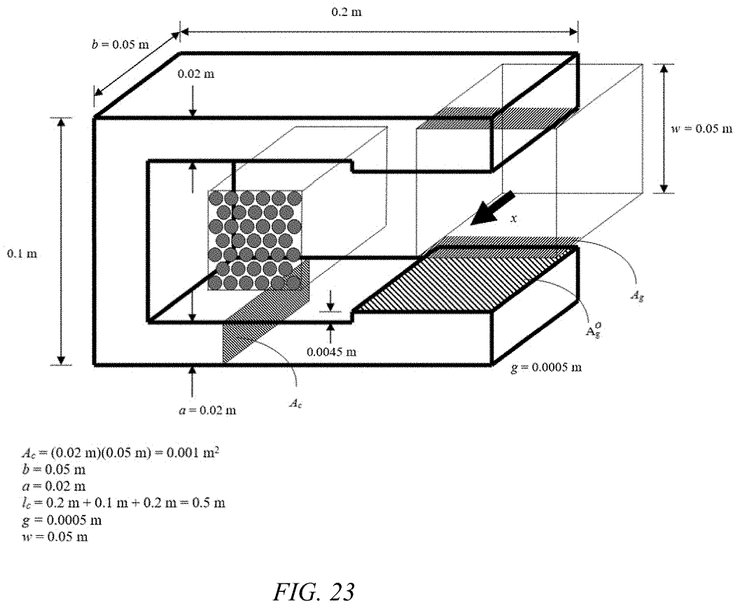

FIG. 23 shows a magnetic circuit in which a flat blade enters a magnetized core. The magnetomotive force F is

F=Ni=F_{c}+F_{g}+F_{b} (1-4)

where

F=magnetomotive force (A·turn)

F_{c}=magnetomotive force dissipated in the core (A·turn)

F_{g}=magnetomotive force dissipated in the air gap (A·turn)

F_{b}=magnetomotive force dissipated in the flat blade (A·turn)

N=number of turns

i=current (A)

The dissipation of magnetomotive force in each section of the magnetic circuit follows:

F=Ni=H_{c}l_{c}+H_{g}l_{g}+H_{b}w (2-5)

where

H_{c}=magnetic field intensity in core (A·turn/m)

H_{g}=magnetic field intensity in air gap (A·turn/m)

H_{b}=magnetic field intensity in flat blade (A·turn/m)

l_{c}=length of core (m)

g=length of air gap (m)

w=width of flat blade (m)

The magnetic flux density is related to the magnetic field intensity as follows:

B=μH (3-6)

where

B=magnetic flux density (Wb/m² or tesla)

μ=magnetic permeability (Wb/(A·turn·m))

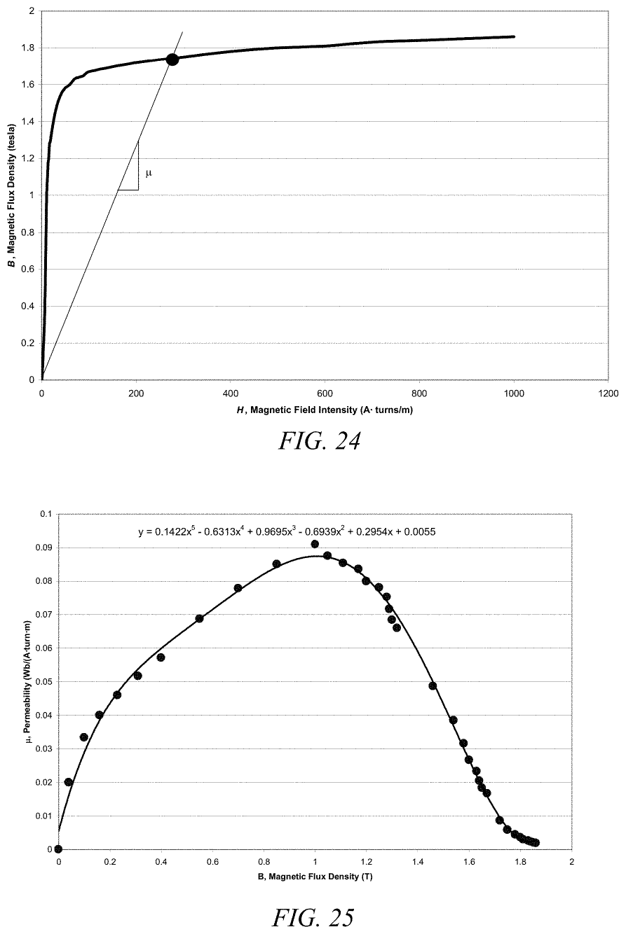

The relationship between B and H is shown in FIG. 24 for 0.012-inch-thick M-5 grain-oriented electrical steel. The magnetic permeability is the slope of the line shown in FIG. 24. FIG. 25 shows the magnetic permeability as a function of B. Substituting Equation 6 into Equation 5 gives

$$F = Ni = \frac{{B}_{c} {l}_{c}}{{μ}_{c}} + \frac{{B}_{g} 2 g}{{μ}_{o}} + \frac{{B}_{b} w}{{μ}_{b}} \qquad ( 4 \text{-} 7 )$$

where
μ_{c}=magnetic permeability in the core (Wb/(A·turn·m))
μ₀=magnetic permeability in the air=magnetic permeability of free space=4π×10⁻⁷ Wb/(A·turn·m)
μ_{b}=magnetic permeability in the flat blade (Wb/(A·turn·m))
   The magnetic flux ϕ is the same everywhere in the circuit and follows:

ϕ=B_{c}A_{c}=B_{g}A_{g}=B_{b}A_{b} (5-8)

where
ϕ=magnetic flux (Wb)
A_{c}=area of the core (m²)
A_{g}=area of the air gap at an instant of time (m²)
A_{b}=area of the flat blade through which the magnetic flux passes at an instant of time (m²)
   If the flat blade width w is small, the field lines do not have enough space to spread out so the magnetic flux density of the air gap and flat blade are about the same, thus allowing the following approximation to be made:

A_{b}≅A_{g} (6-9)

Using this relationship, the magnetic flux density can be calculated in each portion of the magnetic circuit.

$${B}_{c} = \frac{φ}{{A}_{c}} \\ {B}_{\overline{g}} = \frac{φ}{{A}_{g}} \\ {B}_{b} = \frac{φ}{{A}_{b}} \qquad ( 7 \text{-} 10 )$$

Substituting the relationships in Equations 10 into Equation 7 gives the following:

$$F = Ni = \frac{φ {l}_{c}}{{μ}_{c} {A}_{c}} + \frac{φ2 g}{{μ}_{o} {A}_{g}} + \frac{φ w}{{μ}_{b} {A}_{b}} = φ ( \frac{{l}_{c}}{{μ}_{c} {A}_{c}} + \frac{2 g}{{μ}_{o} {A}_{g}} + \frac{w}{{μ}_{b} {A}_{b}} ) \\ φ = \frac{Ni}{( \frac{{l}_{c}}{{μ}_{c} {A}_{c}} + \frac{2 g}{{μ}_{o} {A}_{g}} + \frac{w}{{μ}_{b} {A}_{b}} )} \qquad ( 8 \text{-} 11 )$$

The terms in the brackets are the reluctance R (A·turn/Wb) of each portion of the magnetic circuit.

$$\begin{matrix}F = Ni = φ ( {R}_{c} + {R}_{g} + {R}_{b} ) \\ where & ( 9 \text{-} 12 ) \\ {R}_{c} = \frac{{l}_{c}}{{μ}_{c} {A}_{c}} = reluctance of the core ( A \cdot turn / W b ) \\ {R}_{g} = \frac{2 g}{{μ}_{o} {A}_{g}} = reluctance of the air gap ( A \cdot turn / W b ) \\ {R}_{b} = \frac{w}{{μ}_{b} {A}_{b}} = reluctance of the blade ( A \cdot turn / W b ) & ( 10 \text{-} 13 )\end{matrix}$$

The work required to supply the energy to a magnetic field is

W_{fld}=½L(x)i² (11-14)

where

W_{fld}=work required to supply energy to the magnetic field (J)

L(x)=instantaneous inductance, which is a function of position (Wb·turn/A)

As the flat blade moves through the air gap, the inductance of the circuit increases, thus allowing the magnetic flux to increase. The inductance is

$$L ( x ) = \frac{{N}^{2}}{{R}_{c} + {R}_{g} + {R}_{b}} \qquad ( 12 \text{-} 15 )$$

Substituting the expressions in Equations 13 gives

$$L ( x ) = \frac{{N}^{2}}{\frac{{l}_{c}}{{μ}_{c} {A}_{c}} + \frac{2 g}{{μ}_{o} {A}_{g}} + \frac{w}{{μ}_{b} {A}_{b}}} \qquad ( 13 \text{-} 16 )$$

The areas may be expressed relative to the core area A

$$L ( x ) = \frac{{N}^{2}}{\frac{{l}_{c}}{{μ}_{c} {A}_{c}} + \frac{2 {gA}_{c}}{{μ}_{o} {A}_{g} {A}_{c}} + \frac{{wA}_{c}}{{μ}_{b} {A}_{b} {A}_{c}}} = \frac{{N}^{2} {A}_{c}}{\frac{{l}_{c}}{{μ}_{c}} + \frac{2 {gA}_{c}}{{μ}_{o} {A}_{g}} + \frac{{wA}_{c}}{{μ}_{b} {A}_{b}}} \qquad ( 14 \text{-} 17 )$$

Using the approximation shown in Equation 9, the following equation results

$$L ( x ) = \frac{{N}^{2} {A}_{c}}{\frac{{l}_{c}}{{μ}_{c}} + \frac{2 {gA}_{c}}{{μ}_{o} {A}_{g}} + \frac{{wA}_{c}}{{μ}_{b} {A}_{b}}} = \frac{{N}^{2} {A}_{c}}{\frac{{l}_{c}}{{μ}_{c}} + \frac{{A}_{c}}{{A}_{g}} ( \frac{2 g}{{μ}_{o}} + \frac{w}{{μ}_{b}} )} \qquad ( 15 \text{-} 18 )$$

The instantaneous air gap A_{g} is

$${A}_{g} = \frac{x}{b} {A}_{g}^{o} \qquad ( 16 \text{-} 19 )$$

where

A_{g}^{o}=area of the closed air gap (m²)

b=width of flat blade (m)

x=position of flat blade within air gap (m)

Equation 16 may be substituted into Equation 18

$$L ( x ) = \frac{{N}^{2} {A}_{c}}{\frac{{l}_{c}}{{μ}_{c}} + \frac{{A}_{c}}{{A}_{g}^{o}} \frac{b}{x} ( \frac{2 g}{{μ}_{o}} + \frac{w}{{μ}_{b}} )} \qquad ( 17 \text{-} 20 )$$

Equation 17 may be substituted into Equation 14 to give the work required to build the magnetic field

$${W}_{fld} = \frac{1}{2} \frac{{N}^{2} {A}_{c}}{\frac{{l}_{c}}{{μ}_{c}} + \frac{{A}_{c}}{{A}_{g}^{o}} \frac{b}{x} ( \frac{2 g}{{μ}_{o}} + \frac{w}{{μ}_{b}} )} {i}^{2} = \frac{1}{2} \frac{{( Ni )}^{2} {A}_{c}}{\frac{{l}_{c}}{{μ}_{c}} + \frac{{A}_{c}}{{A}_{g}^{o}} \frac{b}{x} ( \frac{2 g}{{μ}_{o}} + \frac{w}{{μ}_{b}} )} \qquad ( 18 \text{-} 21 )$$

The following definitions

$$A ≡ \frac{1}{2} {( N i )}^{2} {A}_{c} \\ B ≡ \frac{{l}_{c}}{{μ}_{c}} ≅ 0 ( if the core is not saturated ) \\ C ≡ \frac{{A}_{c}}{{A}_{g}^{o}} b ( \frac{\underline{2} g}{{μ}_{0}} + \frac{w}{{μ}_{b}} ) ≅ \frac{{A}_{c}}{{A}_{g}^{o}} b ( \frac{2 g}{{L}_{0}} ) ( if the blade is not saturated ) \qquad ( 19 \text{-} 22 )$$

may be substituted into Equation 21

$${W}_{fld} = \frac{A}{B + \frac{C}{x}} \qquad ( 20 \text{-} 23 )$$

The force f acting on the flat blade as the magnetic flux increases follows:

$$f = - \frac{\partial {W}_{fld}}{\partial x} \qquad ( 21 \text{-} 24 )$$

Taking the derivative of Equation 23 gives

$$f = - A \frac{\frac{C}{{x}^{2}}}{{( B + \frac{C}{x} )}^{2}} \qquad ( 22 \text{-} 25 )$$

If the core and flat blade are not saturated then Equation 25 simplifies to

$$f = \frac{A}{C} = - \frac{\frac{1}{2} {( Ni )}^{2} {A}_{c}}{\frac{{A}_{c}}{{A}_{g}^{o}} b ( \frac{2 g}{{μ}_{o}} )} = - ( \frac{{μ}_{o}}{4 g} ) {( Ni )}^{2} \frac{{A}_{c}}{b} ( \frac{{A}_{g}^{o}}{{A}_{c}} ) \qquad ( 23 \text{-} 26 )$$

This equation indicates that as long as the core is not saturated, the force acting on the flat blade will be constant and independent of position. Further, for a given core area A_{c} and magnetomotive force Ni, the force increases with a smaller gap g, it increases with larger close air gap area A°, and it decreases with greater flat blade width b.

Using the following procedure, the equations above allow the calculation of the force in a flat blade, allowing for saturation of the core:
1. Specify the following: A_{c}, A_{g}^{o}/A_{c}, b, l_{c}, w, g, Ni, x
2. Guess ϕ
3. Calculate B_{c}, B_{g}, and B_{b} (Equations 10)
4. Calculate μ_{c} and μ_{b} (FIG. 3) ρμ=0.1422B⁵−0.6313B⁴+0.9695B³−0.6939B²+0.2954B+0.0055 for 0.012 M-5 grain-oriented electrical steel, valid up to B=1.9 Wb/m²
5. Calculate ϕ (Equation 11)
6. Iterate Steps 2 to 5 until convergence
7. Calculate A, B, and C (Equations 22)
8. Calculate f (Equation 25)

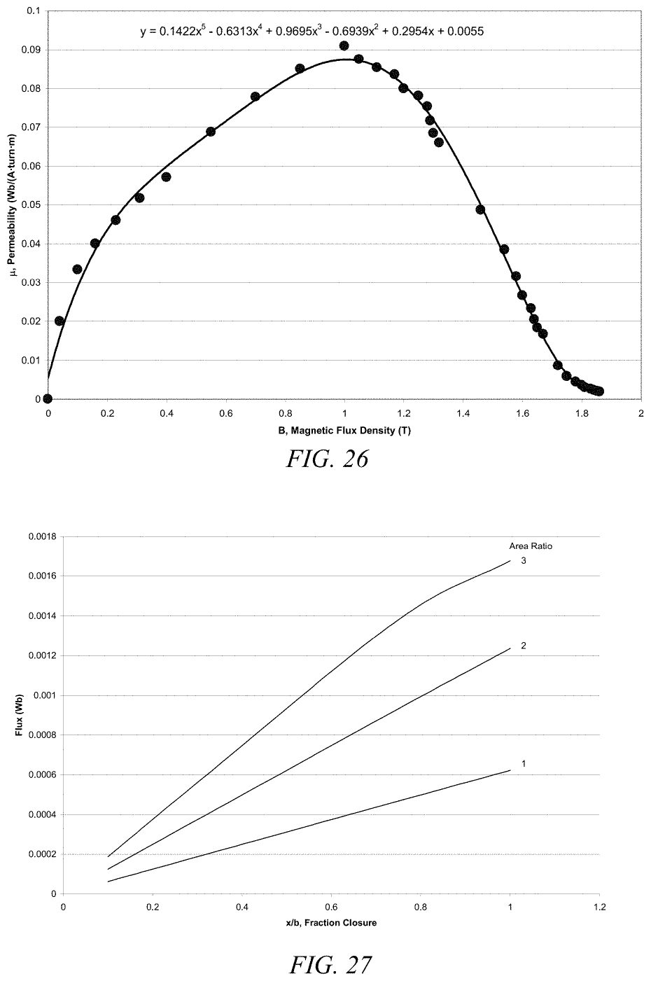

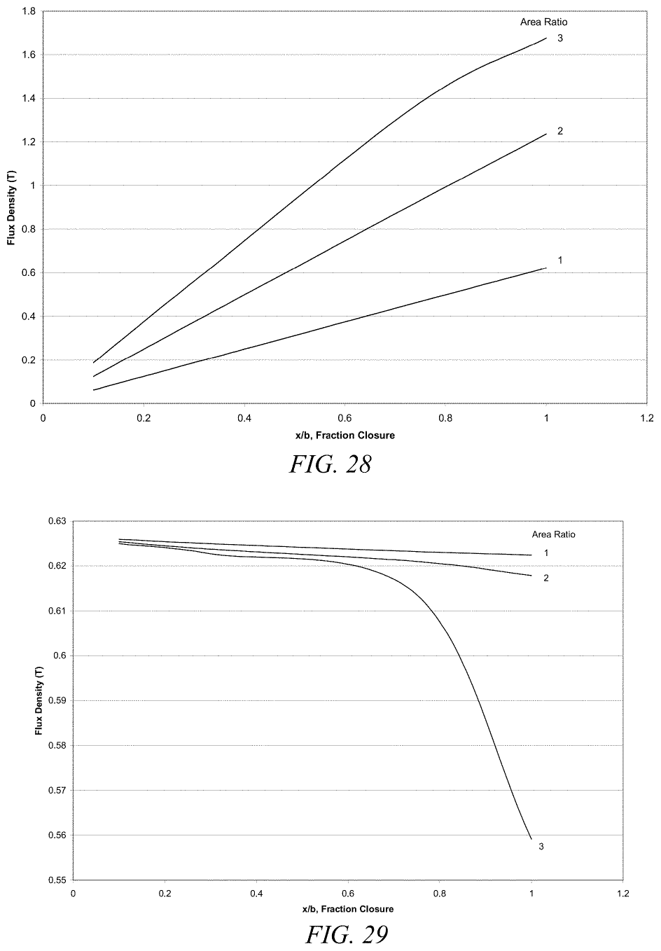

FIG. 23 shows the flat blade geometry that was evaluated. FIG. 26 shows the force f is constant with respect to fractional closure (x/b), except for high area ratios (A_{g}^{o}/A_{c}) when the core starts to saturate. FIG. 27 shows that the magnetic flux ϕ increases linearly with fractional closure, except for high area ratios (A_{g}^{o}/A_{c}) when the core starts to saturate. FIG. 28 shows that the core magnetic flux density B_{c} has a similar pattern as ϕ, which is expected because the two quantities are related by the core area A_{c}, which is constant. Lastly, FIG. 29 shows B_{g} and B_{b}, which are nearly constant for each area ratio A_{g}^{o}/A_{c} and fractional closure, except when the core starts to saturate at high area ratios.

In a torque-dense electric motor, the core should saturate (maximum B) just as the air gap is fully closed. This strategy takes maximum advantage of the flux carrying capacity of the core. In FIG. 28, only an area ratio of 3 caused the core to saturate with the Ni used in this study (500 A·turns). It would be possible to saturate the core of the smaller area ratios (1 and 2) if Ni were increased; however, this comes at the expense of increased wire bundle area. The main advantage of the increased area ratio is that it can cause saturation of the core with a small Ni, and hence increase the force acting on the blade. This increased force with small Ni must come from somewhere—it comes from an increase in voltage that delivers the current. Thus, when the area ratio increases, it allows for a smaller Ni, and a larger voltage.

FIG. 26 shows that for a given Ni, the force on the blade increases with area ratio. This occurs because greater area ratios reduce the reluctance of the air gap, which is the dominant reluctance in the magnetic circuit. Operationally, the interface between the rotor and stator should have the greatest surface area possible, which reduces the reluctance of the flow of magnetism between the rotors and stators. The slanted cut described above is one way to accomplish this objective.

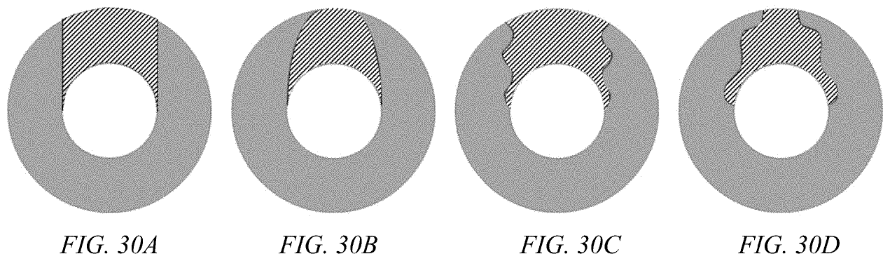

FIGS. 30A, 30B, 30C, and 30D show some examples of magnetic circuits with high-surface-area air gaps. Although particular examples have been provided, a person skilled in the art may take this disclosure and apply them to create other high-surface-air gaps. If one is confined to a circular circuit, these linear cuts in FIG. 30A maximize interfacial surface area. If one is not constrained to a linear cut, one can employ curved cuts such as shown in FIG. 30B. If one overlays a sinusoid (or similar geometry) on a linear cut, one arrive at FIG. 30C. If one overlays a sinusoid (or similar geometry) on a curve, one arrives at FIG. 30D.

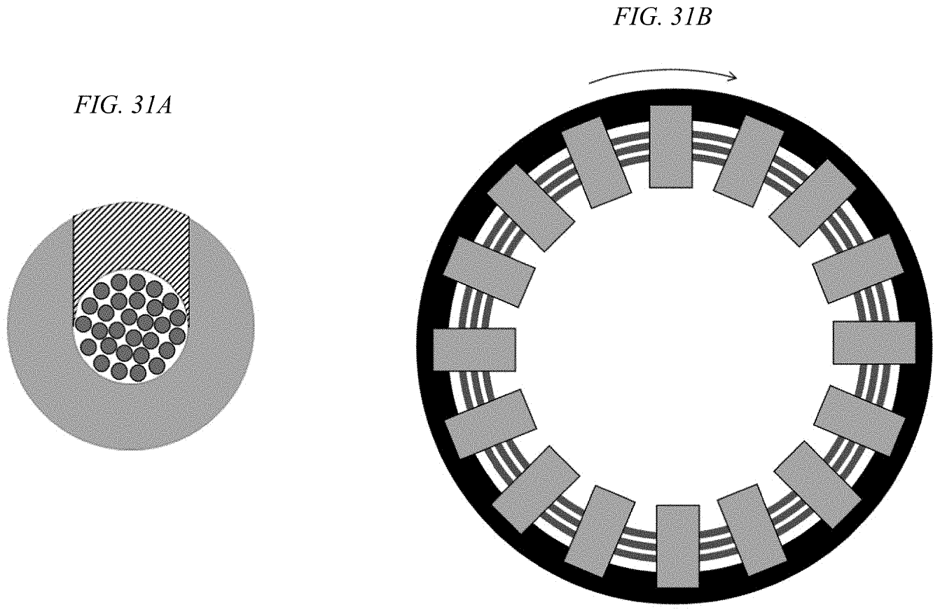

FIG. 31A shows the magnetic circuit in the 12 o'clock position of FIG. 31B a motor/generator in which the rotor is outside the stator. The electrically conducting coil is located at the center of the magnetic circuit. When it is energized, all magnetic circuits are energized simultaneously. The rotor goes into the gap indicated by the cross hatches. In the case of high-surface-area gaps (e.g., FIGS. 8b, 8c, and 8d), the curved surface must revolve around the axis to maintain a tight air gap at all angular positions.

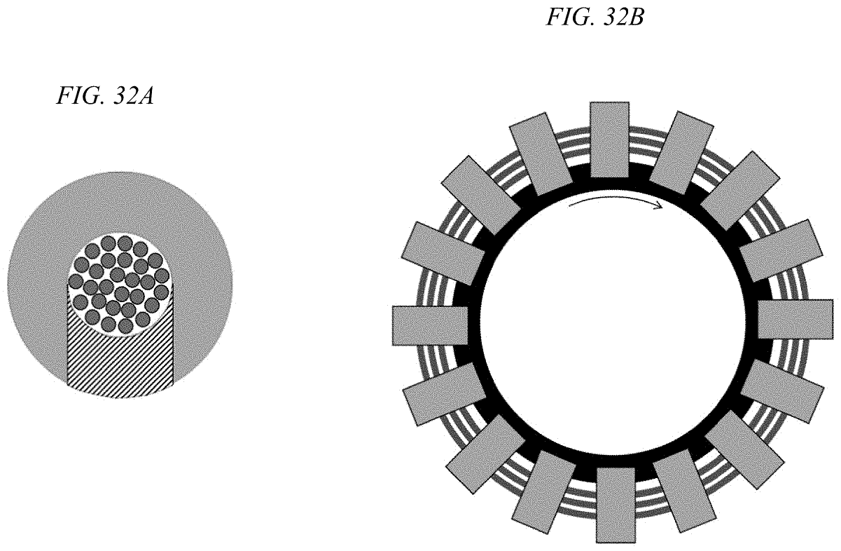

FIG. 32A shows the magnetic circuit in the 12 o'clock position of FIG. 32B, a motor/generator in which the rotor is inside the stator. The electrically conducting coil is located at the center of the magnetic circuit. When it is energized, all magnetic circuits are energized simultaneously. The rotor goes into the gap indicated by the cross hatches. In the case of high-surface-area gaps (e.g., FIGS. 8b, 8c, and 8d), the curved surface must revolve around the axis to maintain a tight air gap at all angular positions.

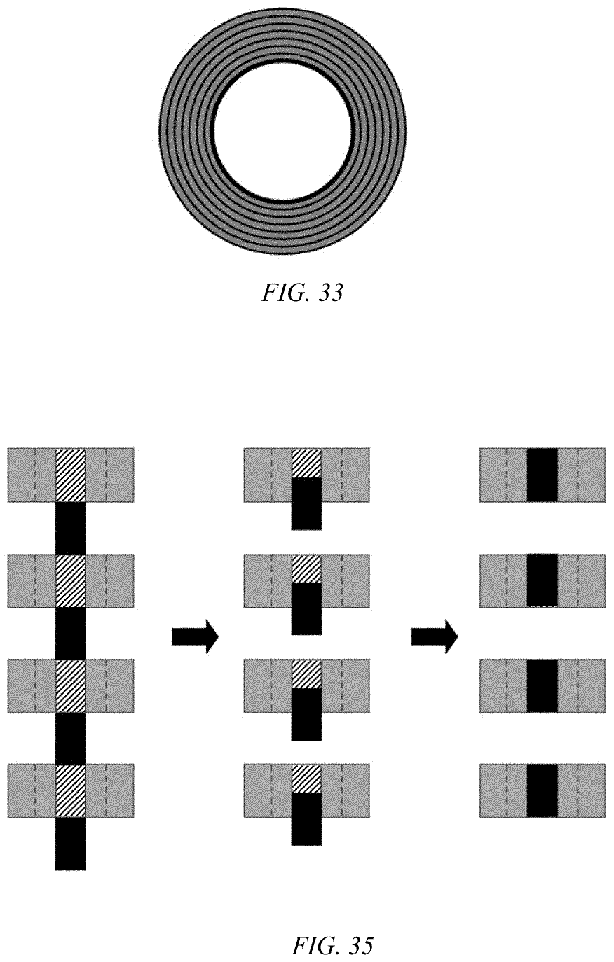

FIG. 33 shows the magnetic circuit is created from iron laminations, which reduces eddy currents and thereby improves efficiency. Alternatively, the magnetic circuit can be created from soft magnetic composites (SMC) rather than laminates. This approach allows for a greater variety of shapes and better heat transfer.

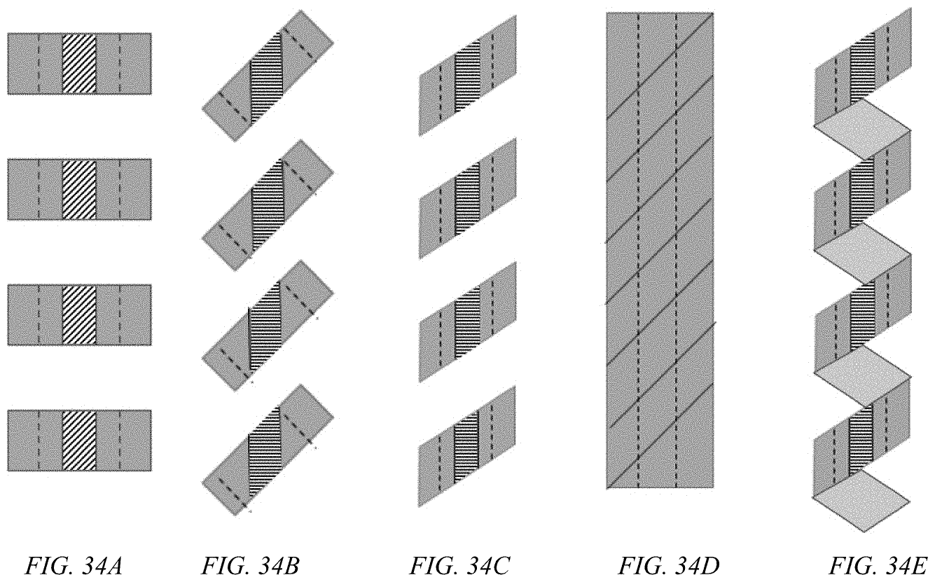

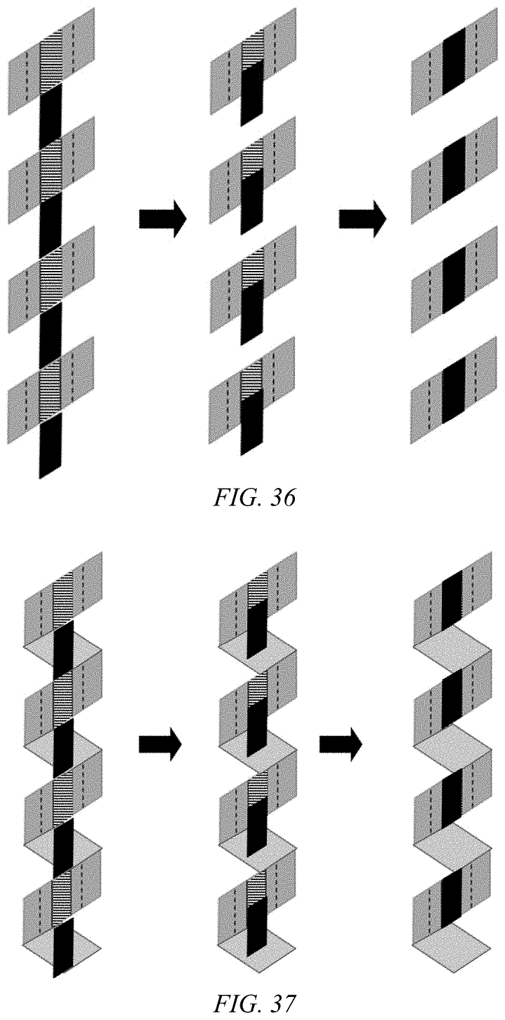

FIGS. 34A, 34B, 34C, 34D, and 34E show non-limiting options for the iron in the magnetic circuit. FIG. 34A shows a magnetic circuit that is at a right angle to the plane in which the rotor rotates. FIGS. 34B, 34C, and 34E show magnetic circuits that are at an angle (e.g., 45 degrees) relative to the plane in which the rotor rotates. In this angled arrangement, the area of the air gap is substantially larger than the cross-sectional area of the magnetic circuit, which increases the force on the rotor (FIG. 26).

In FIGS. 34A and 34B, the magnetic circuits could be created by wrapping strips of iron laminate material around a mandrel. In contrast, the magnetic circuits shown in FIGS. 34C and 34E could be created by wrapping sheets of iron laminate around a mandrel to form a “jelly roll” (FIG. 34D). In FIG. 34C, each magnetic circuit would be created by slicing the “jelly roll” at the angles shown in FIG. 34D. The magnetic circuits in FIG. 34E form a spiral, which could be created by making a spiral cut in the “jelly roll.”

FIG. 35 shows the rotor closing the gaps in the magnetic circuit shown in FIG. 34A. The gap can be closed by iron (switched reluctance motor) or magnets (permanent magnet motor).

FIG. 35 shows the rotor closing the gaps in the magnetic circuit shown in FIG. 34C. The gap can be closed by iron (switched reluctance motor) or magnets (permanent magnet motor).

FIG. 37 shows the rotor closing the gaps in the magnetic circuit shown in FIG. 34E. The gap can be closed by iron (switched reluctance motor) or magnets (permanent magnet motor).

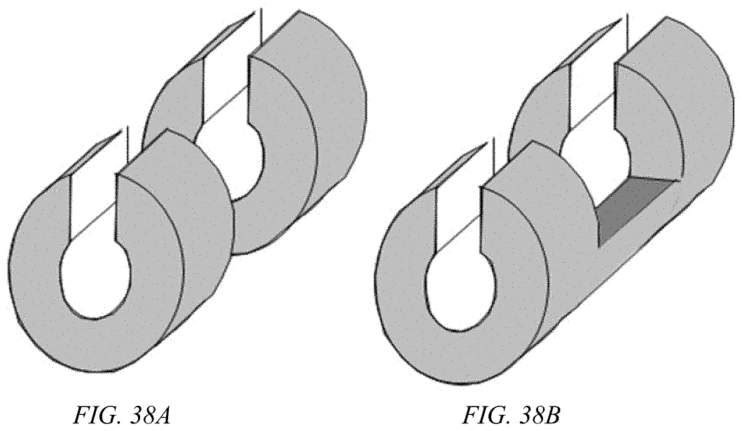

FIG. 38A shows the magnetic circuits previously described in FIG. 34A. In this case, there is no magnetic shielding. FIG. 38B shows the magnetic circuits previously described in FIG. 34A. In this case, there is magnetic shielding, which increases the magnetic strength in the gaps and thereby increases the force acting on the rotor. This same principle can be implemented with the other magnetic circuits described in FIGS. 34A-34E.

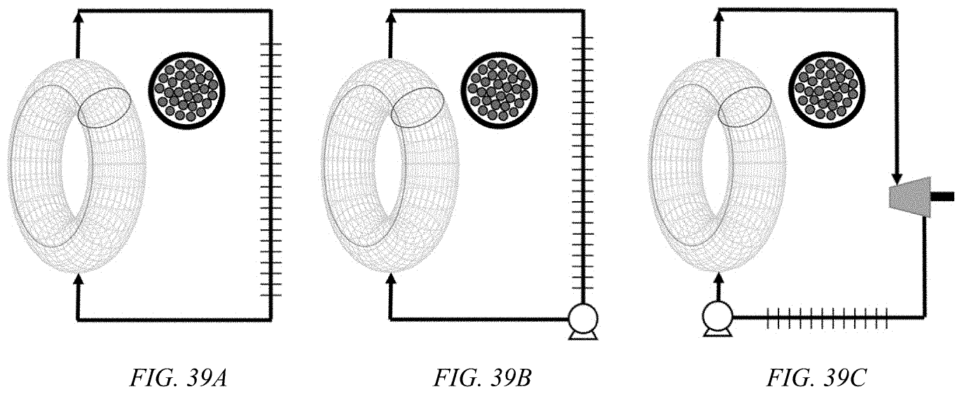

FIGS. 39A, 39B, and 39C show cooling systems for the copper coil that is located at the center of the magnetic circuits. To remove waste heat produced as current flows through the copper coil, the copper coil is contained within a sealed torus through which cooling fluid circulates and thus allows a heat transfer fluid (e.g., refrigerant) to directly contact the copper wires and remove waste heat. This waste heat can be dissipated into the environment through a heat exchanger that is distant from the motor/generator. If the heat transfer fluid vaporizes, the vapors can go into a heat exchanger located above the motor/generator. When the heat transfer fluid condenses, it will flow by gravity back into the torus. In this mode of operation, the cooling system is functioning as a heat pipe. Of course, another option is to simply pump a liquid through the torus and dissipate the heat in a heat exchanger that can be located anywhere.

If the motor/generator operates at a high temperature, the heat transfer fluid will be at high temperature thus allowing work to be recovered via a heat engine. For example, the heat transfer fluid could boil at an elevated temperature and pressure. When it flows through an expander, work can be produced. Ultimately, the remaining waste heat is disposed in the environment. Another option is to dissipate the waste heat through a thermoelectric generator that produces electricity directly from the heat that passes through it.

FIG. 39A shows a thermosiphon in which liquid coolant boils inside the torus. The vapors that emit from the top enter a condenser, which forms liquid. The liquid column in the condenser is slightly higher than the liquid column in the torus, which causes flow without the need for a pump.

FIG. 39B shows a pumped liquid coolant that flows through the torus.

FIG. 39C shows the torus is part of a Rankine cycle engine. Pressurized liquid is pumped into the torus and exits as high-pressure vapor, which enters an expander to produce shaft work. The low-pressure vapors exiting the expander are condensed and recycled back to the torus.

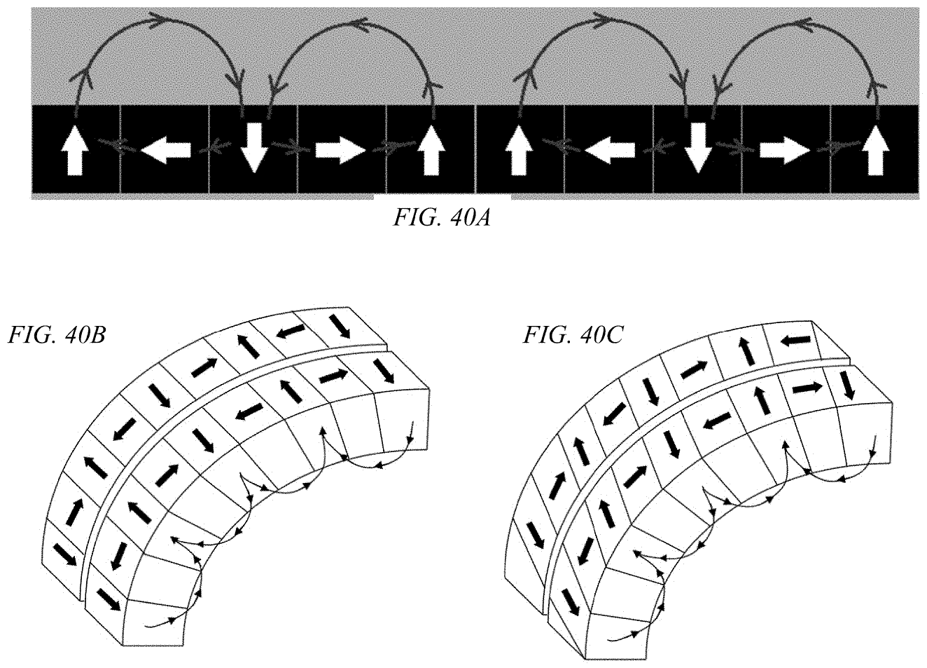

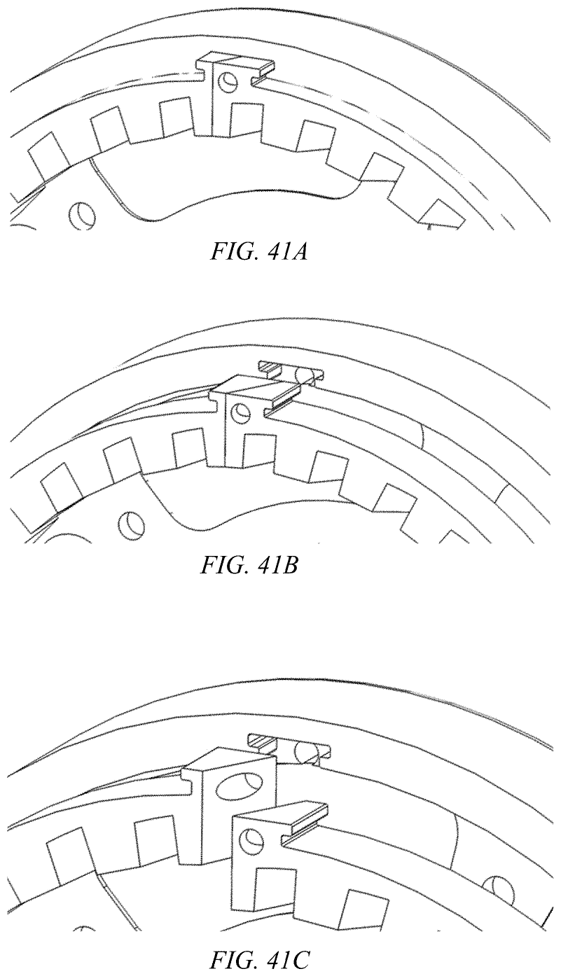

FIG. 40A shows a Halbach array in which the magnetic fields align to produce a strong magnetic field on one side and a weak magnetic field on the other. In such a configuration, the rotor can have such a Halbach array rather than iron or a permanent magnet. Two rows of Halbach arrays are placed on the rotor with strong fields pointing outward. The Halbrach arrangement shown in FIG. 40B is used with the magnetic circuit shown in FIG. 34A and the Halbrach arrangement shown in FIG. 40C is used with the magnetic circuits shown in FIGS. 34B, 34C, and 34E.

If the motor/generator stops in a random position, it can be difficult for the motor controller to find the right starting sequence. This problem can be avoided by using a “parking magnet,” an extra magnet that established a preferred orientation when the motor/generator is turned off.

FIGS. 41-41C illustrate a T-lock Joint which enables secure alignment of an outer rim to an inner carrier for a wheel motor or “outrunner” or “inside-out: type electric motor. In particular, FIG. 41A shows a T-lock joint assembled (through bolt not shown in hole).

FIG. 41B shows a T-lock joint partially disassembled. FIG. 41C shows a T-lock joint fully disassembled.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system
comprising: a stator
and a rotor,
wherein an interface between the stator and the rotor provide a magnetic circuit at an angle relative to the plane in which the rotor rotates.

2. The system of claim 1, wherein the angle is 45 degrees.

3. The system of claim 1, wherein the angle is other than 45 degrees.

4. The system of claim 1, wherein the interface on one of the stator or rotor is linear.

5. The system of claim 1, wherein the interface on one of the stator or rotor is curved.

6. The system of claim 1, wherein the interface on one of the stator or rotor is a sinusoid or similar geometry applied to a linear design.

7. The system of claim 1, wherein the interface on one of the stator or rotor is a sinusoid or similar geometry applied to a curved design.
